(19) United States
(12) Patent Application Publication
(10) Pub. No.: US 2013/0323603 A1
(43) Pub. Date: Dec. 5, 2013

(54) SOLID HIGH-IONIC CONDUCTOR FOR BATTERY AND LITHIUM-SULFUR BATTERY USING THE SAME

(71) Applicant: HUYNDAI MOTOR COMPANY, Seoul (KR)

(72) Inventors: Hee Yeon Ryu, Uiwang (KR); Yoon Ji Lee, Uiwang (KR); Hee Jin Woo, Uiwang (KR); Jun Ki Rhee, Uiwang (KR)

(73) Assignee: HYUNDAI MOTOR COMPANY, Seoul (KR)

(21) Appl. No.: 13/656,887

(22) Filed: Oct. 22, 2012

(30) Foreign Application Priority Data
Jun. 4, 2012 (KR) 10-2012-0059761

(51) Int. Cl. H01M 10/0562; H01M 4/36

(52) U.S. Cl. 429/320; 429/122; 429/322; 429/231.5

(57) ABSTRACT

The present invention provides a lithium-sulfur battery using a solid high-ionic conductor in a three-dimensional (3D) porous structure. In particular, at a higher temperature (120° C. or higher) than a melting temperature, the lithium-sulfur battery does not have fluid sulfur leaking outside of a battery cell electrode. The lithium-sulfur battery can be operated at both a high temperature and room temperature. The battery of the invention can be used without performance degradation and with increased ion conductivity at a high temperature, thus improving the battery's power performance.

### CROSS-REFERENCE TO RELATED APPLICATION

This application claims under 35 U.S.C. §119(a) the benefit of Korean Patent Application No. 10-2012-0059761 filed on Jun. 4, 2012, the entire contents of which are incorporated herein by reference.

### BACKGROUND

(a) Technical Field

The present invention provides a solid high-ionic conductor for a battery and a lithium-sulfur battery using the same. In particular, the present invention provides a complex solid high-ionic conductor for a battery, which is capable of preventing sulfur leakage from a lithium-sulfur battery at a temperature higher than its melting temperature, thus enabling the lithium-sulfur battery to be operated at a high temperature as well as room temperature. In another aspect, the invention provides a lithium-sulfur battery using the solid high-ionic conductor.

(b) Background Art

Since early 1970s, a lithium-sulfur battery has been studied as a potential substitute for a sodium-sulfur battery for the purpose of replacing sodium with lithium when operated at high temperatures. The initial study was concentrated on a lithium-sulfur battery operating only at a high temperature by using a solid ionic conductor. The study has now been extended to include a lithium-sulfur battery operating at room temperature by using an organic electrolyte.

In 1970s, the ion conductivity of a solid ionic conductor was very low at room temperature. Consequently, the battery could operate only at a higher temperature than 200° C. In recent years, the ion conductivity has been tested at a level that allows the battery to operate at room temperature. It thus allows the inclusion of a solid high-ionic conductor into a lithium-sulfur battery. However, it has been observed that a high interfacial resistance occurs between solids when a conventional solid high-ionic conductor in the form of a powder is used in a battery cell. Recent studies have focused on reducing an interfacial resistance between an electrode active material and a solid high-ionic conductor.

In general, the ion conductivity of the solid high-ionic conductor increases as the temperature rises. When a solid high-ionic conductor is used in a lithium-sulfur battery, it is preferable to have the solid high-ionic conductor made in a way that it can operate at a high temperature as well as room temperature. Since sulfur, if used as a cathode active material of the lithium-sulfur battery, becomes fluid at a temperature higher than its meting temperature, it may leak outside the battery cell.

### SUMMARY OF THE INVENTION

The present invention has been made in an effort to solve the above-described problems associated with prior art. In particular, the present invention provides a solid high-ionic conductor for a battery, which can prevent leakage of sulfur at a higher temperature than its melting temperature, thereby allowing a lithium-sulfur battery to be operated at both a high temperature and room temperature. The invention also provides a lithium-sulfur battery using the solid high-ionic conductor.

In one aspect, the present invention provides a complex solid high-ionic conductor for a battery. The complex solid high-ionic conductor includes a porous portion that is a porous flat-plate structure comprising a plurality of pores which can be filled with an electrode active material and a dense portion which contains a side edge of the porous portion. The dense portion is constructed to prevent an electrode active material from leaking at a higher temperature than the melting temperature of the electrode active material.

In one embodiment, an interfacial surface between the porous portion and the electrode active material is coated with a reaction activation material to improve an interfacial reaction. The reaction activation material is selected from Al-based, In-based, Al₂O₃-based, ZrO₂-based, and ceramic-based materials.

In certain embodiments, the porous portion is a three-dimensional (3D) porous structure, which is made by a method, such as, a freeze casting method, a sol-gel method, a colloidal crystal template method, a carbon template method, an aerogel synthesis method, or a tape casting method.

Each of the porous portion and the dense portion is made by a material selected from LiSICON-based, Thio-LiSICON-based, NaSiCON-based, Perovskite-based, Garnet-based, LiPON-based, LiPOS-based, LiSON-based, and LiSIPON-based materials.

In another aspect, the present invention provides a lithium-sulfur battery comprising a cathode that includes a cathode solid high-ionic conductor, an anode including an anode solid high-ionic conductor, and a separation film inserted between the cathode and the anode. The cathode solid high-ionic conductor contains a porous portion that is a porous flat-plate structure; a dense portion, that contains a side edge of the porous portion; and a cathode binder that is filled into each pore of the porous portion. The anode solid high-ionic conductor comprises a porous portion, which is a porous flat-plate structure; a dense portion, which encloses a side edge of the porous portion; and a lithium-based metal that is filled into each pore of the porous portion. The separation film inserted between the cathode and the anode prevents leakage of the cathode binder filled into the pore at a higher temperature than its melting temperature.

In certain embodiments, the cathode includes a cathode current collector coupled to a surface of the cathode solid high-ionic conductor opposite to the separation film, and the anode includes an anode current collector coupled to a surface of the anode solid high-ionic conductor opposite to the separation film.

In one embodiment, the cathode is in a thickness of 20-500 μm, the anode is in a thickness of 5-500 μm, and the separation film is in a thickness of 1-20 μm. An interfacial surface in one or both of the cathode and the anode is coated with a reaction activation material selected from Al-based, In-based, Al₂O₃-based, ZrO₂-based, and ceramic-based materials to improve an interfacial reaction between the solid high-ionic conductor and the electrode active material.

Each of the porous portion, the dense portion, and the separation film is made of a material selected from LiSICON-based, Thio-LiSICON-based, NaSiCON-based, Perovskite-based, Garnet-based, LiPON-based, LiPOS-based, LiSON-based, and LiSIPON-based materials.

A cathode binder or lithium-based metal is filled into each pore of the porous portions, by a melting method, a thin-film coating method, or a powder particle paste filling method.

In another aspect, the present invention provides an electrode for a lithium-sulfur battery. The electrode comprises a solid high-ionic conductor including a porous portion in a porous flat-plate structure, and a dense portion that contains a side edge of the porous portion, a cathode binder or lithium-based metal that is filled into each pore of the porous portion, and a current collector coupled to a surface of the solid high-ionic conductor. Other aspects and embodiments of the invention are discussed infra.

### BRIEF DESCRIPTION OF THE DRAWINGS

The present invention is further described in detail with reference to exemplary embodiments thereof as illustrated the accompanying drawings. The drawings given herein below are for illustration, which are not intended to be limitative of the present invention:

FIG. 1 is a schematic diagram showing a structure of a complex solid high-ionic conductor for a battery according to an embodiment of the present invention;

FIG. 2 is a plane view showing a complex high-ionic conductor for a battery according to an embodiment of the present invention;

FIG. 3 shows a plane view and a perspective view showing a structure of a complex solid high-ionic conductor for a battery according to another embodiment of the present invention; and

FIGS. 4A through 4D are flowcharts schematically showing a process of manufacturing a lithium-sulfur battery using a complex solid high-ionic conductor for a battery according to an embodiment of the present invention.

It should be understood that the appended drawings are not necessarily to scale, presenting a somewhat simplified representation of various features illustrative of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention.

### DETAILED DESCRIPTION

Hereinafter, exemplary embodiments of the present invention will be described in detail with reference to the accompanying drawings to allow those of ordinary skill in the art to easily carry out the present invention. While the invention will be described in conjunction with the exemplary embodiment, it will be understood that present description is not intended to limit the invention to the exemplary embodiment. On the contrary, the invention is intended to cover not only the exemplary embodiments, but also various alternatives, modifications, equivalents and other embodiments, which may be included within the spirit and scope of the invention as defined by the appended claims.

The present invention provides a lithium-sulfur battery using a complex solid high-ionic conductor composed of a three-dimensional (3D) porous material. By using a complex solid high-ionic conductor of the invention, leakage of sulfur that becomes fluid at a temperature (120° C. or higher) higher than its melting temperature can be prevented. The lithium-sulfur battery operable at a high temperature as well as room temperature can be obtained. The battery of the invention can be used without performance degradation. The battery's power performance is improved as the ion conductivity is increased at a high temperature.

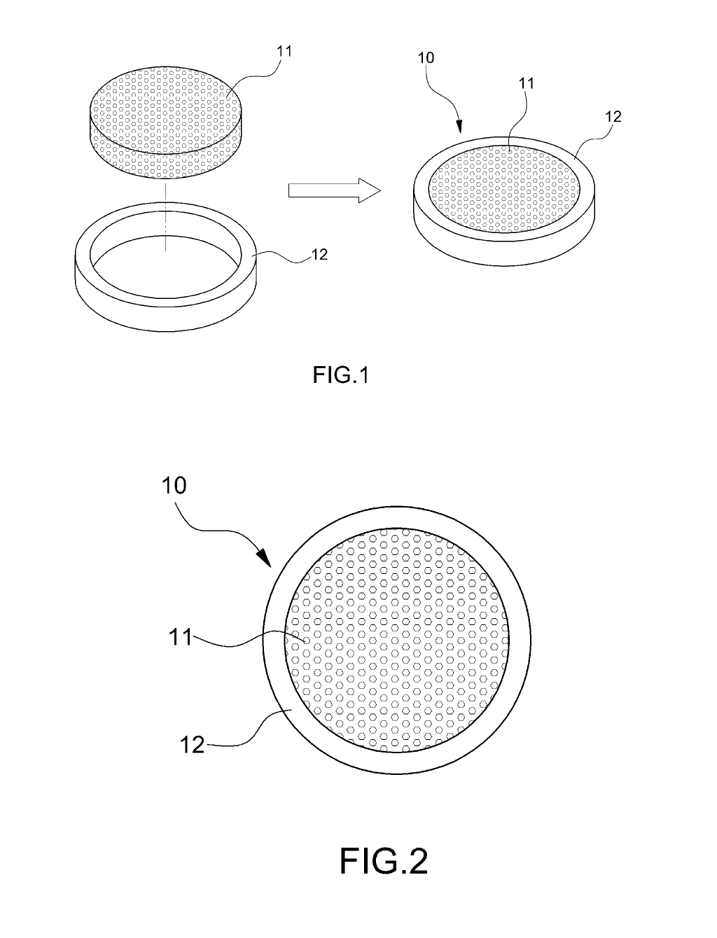

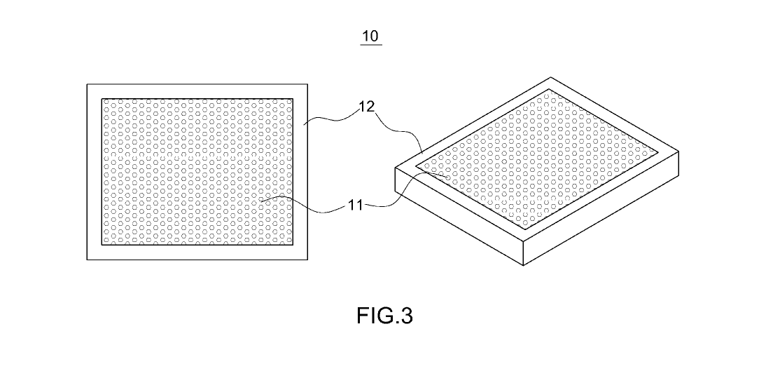

FIGS. 1 through 3 show a structure of a complex solid high-ionic conductor 10 according to an embodiment of the present invention, in which the complex solid high-ionic conductor 10 is a porous flat-plate structure of a predetermined thickness, which includes a porous portion 11 and a dense portion 12.

As shown, the complex solid high-ionic conductor 10 is constructed to have the porous portion 11, which is a 3D porous material having a plurality of pores, inserted into the dense portion 12 which has a dense structure without any pore.

The dense portion 12 is in the form of a seamless closed ring (or closed loop).The porous portion 11 is a porous flat-plate body in a form corresponding to an empty space of the dense portion 12.

The dense portion 12 seamlessly and globally encloses a side edge of the porous portion 11 having a predetermined thickness. When electrode slurry filled into the pores of the porous portion 11 becomes fluid at a temperature higher than its melting temperature, the dense portion 12 prevents leakage of the fluid at the side edge to outside.

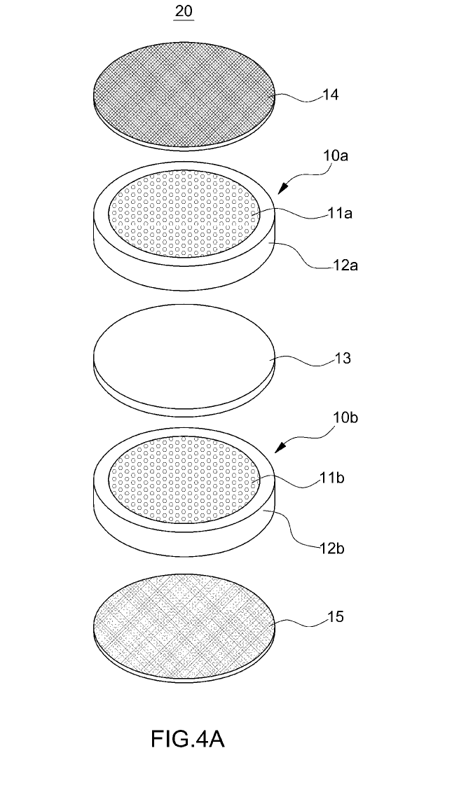

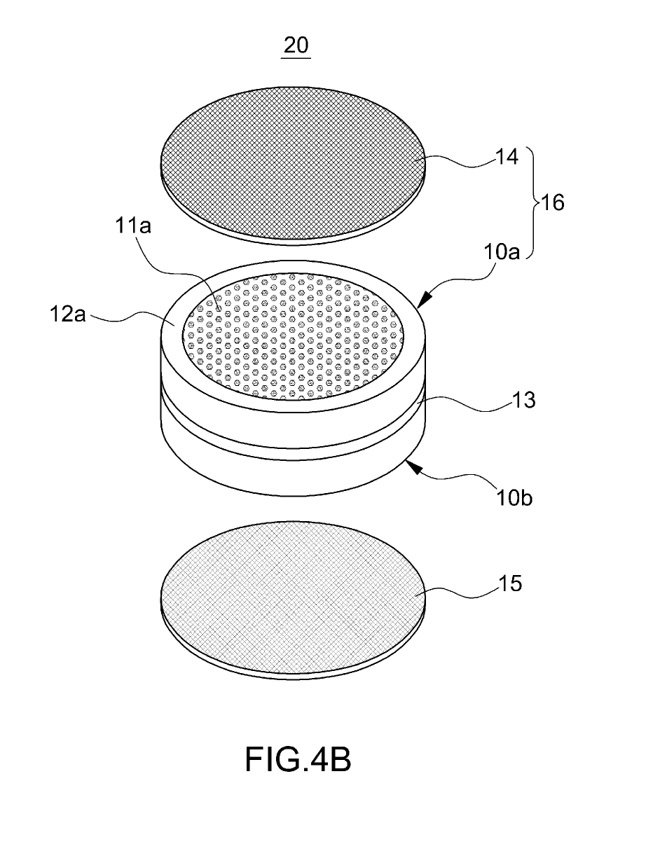

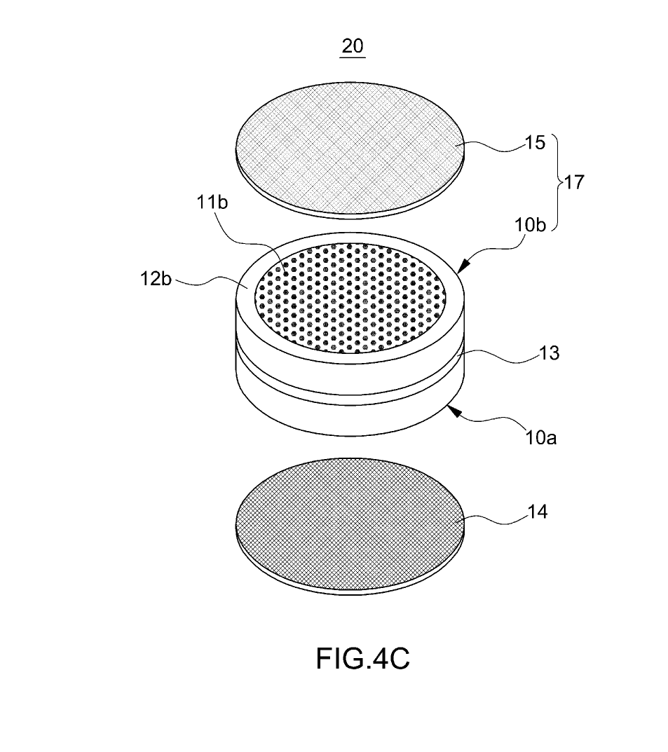

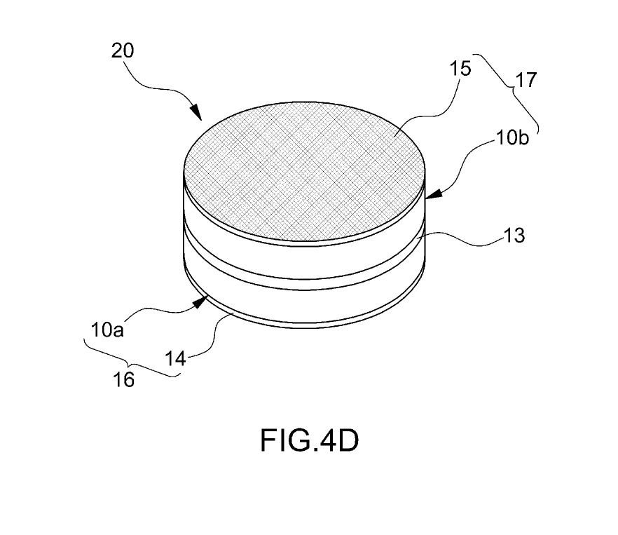

The dense portion 12 together with collectors (14 and 15 of FIG. 4A) and a separation film (13 of FIG. 4A used in manufacturing a battery cell completely seals an outer surface of the porous portion 11, thereby preventing the melted electrode slurry from leaking outside of the electrode of the battery cell.

The dense portion 12 may be in the form of a circular or square ring, for example, as those shown in FIGS. 1 and 3.

The complex solid high-ionic conductor 10 has a dense structure (dense portion) only at a contour portion of a porous flat-plate structure (porous portion). The dense portion 12 is located at an outer side and the porous portion 11 is located at an inner side relative to the dense portion 12. The present invention is not limited by the shape of the solid high-ionic conductor 10.

FIG. 1 shows a disassembled state and an assembled state between the porous portion 11 and the dense portion 12 of the solid high-ionic conductor 10. When the solid high-ionic conductor 10 is made as one piece, in a single flat-plate structure, only an inner portion is made porous according to a processing method, or depending on circumstances. The porous portion 11 and the dense portion 12 may be made in the form of green bodies, respectively. The porous portion 11 and the dense portion 12 may be coupled as one piece through a binder.

A freeze casting method, a sol-gel method, a colloidal crystal template method, a carbon template method, an aerogel synthesis method, a tape casting method, or the like may be used to make the porous portion 11.

In particular, the carbon template method, the sol-gel method, and the colloidal crystal template method offer advantages, such as, facilitating arrangement and adjusting size of each of a plurality of pores. According to the freeze casting method, arrangement can be made to grow in the form of a rod.

The porous portion 11 can be adjusted in terms of pore size, porosity, pore volume, specific surface area, etc. Optimal capacity of a battery cell can be achieved with a space including an electrode active material.

The plurality of pores of the porous portion 11 all are open pores. The size of each pore may vary with a battery system which contains the solid high-ionic conductor 10. The optimal size of each pore is determined according to an electrode active material filled into the pore. In certain embodiments, the pore size is preferably in a range of 0.01-50 μm, to maximize interfacial reactivity between the porous portion 11 and the electrode active material in the pore.

The porosity of the porous portion 11 is in a range of 20-90%, taking account of a minimum amount of the solid high-ionic conductor 10 needed for securing ion conductivity, the maximum electrode active material to be used in manufacturing a battery cell manufacturing,and also mechanical stability desired for the application. In a particular embodiment, the porosity of the porous portion 11 is 70% or higher (i.e., 70-90%) to make a high-energy-density lithium-sulfur battery. An interfacial surface of the porous portion 11, that is, a pore surface of the porous portion 11 is coated with a thin film by a reaction activation material, such as, an Al-based, In-based, Al₂O₃-based, ZrO₂-based, or ceramic-based material, to minimize an interfacial resistance between the porous portion 11 and the electrode active material.

Oxide-based and sulfide-based materials may be used as materials for the solid high-ionic conductor 10. In certain embodiments, materials of crystalline and amorphous (glassy) structures, such as, LiSICON-based, Thio-LiSICON-based, NaSiCON-based, Perovskite-based, Garnet-based, LiPON-based, LiPOS-based, LiSON-based, LiSIPON-based materials, etc., may be used.

The porous portion 11 and the dense portion 12 that form the solid high-ionic conductor 10 may be made from any material selected from LiSICON-based, Thio-LiSICON-based, NaSiCON-based, Perovskite-based, Garnet-based, LiPON-based, LiPOS-based, LiSON-based, LiSIPON-based materials.

For example, a LiSICON-based material, such as, a γ-Li₃PO₄ derivative and an Li_{1+x+y}Alₓ(Ti,Ge)₂₊ₓSi_{y}P_{3-y}O₁₂ derivative, may be used; a Thio-LiSICON-based material, such as, an Li_{3.25}Ge_{0.25}P_{0.75}S₄ derivative, may be used; an NaSiCON-based material, such as, an NaZr₂P₃O₁₂ derivative, may be used; a Perovskite-based material, such as, an La_{2/3}Li_{1/3}TiO₃ derivative, may be used; and a Garnet-based material, such as, an Li₅La₃M₂O₁₂(M=Ta,Nb) derivative, may be used.

In certain embodiments, the porous portion 11 and the dense portion 12 are made from the same material In other embodiments, the porous portion 11 and the dense portion 12 may be made from different material having a similar thermal expansion coefficient.

By using the solid high-ionic conductor 10, a lithium-sulfur battery cell operable at a high temperature as well as room temperature can be made.

FIGS. 4A through 4D are schematic diagrams showing a process of manufacturing a lithium-sulfur battery cell by using the solid high-ionic conductor. As shown, a battery cell 20 using solid high-ionic conductors 10a and 10b contains a cathode solid high-ionic conductor 10a containing a porous portion 11a with pores thereof filled with a cathode binder, a cathode 16 including a cathode current collector 14, an anode solid high-ionic conductor 10b containing a porous portion 11b with pores filled with lithium-based metal, an anode 17 including an anode current collector 15, and a separation film 13 inserted between the cathode 16 and the anode 17. All the above components are manufactured as one piece type or a coupling type.

The cathode and anode solid high-ionic conductors 10a and 10b containing the porous portions 11a and 11b with pores filed with a cathode binder (or cathode slurry) including a sulfur-based cathode active material and lithium-based metal, respectively.

Each pore of the cathode porous portion 11a is filled with the cathode binder including the sulfur-based cathode active material, a conductive material, in the form of slurry by using a solvent, such as, N-Methyl-2-pyrrolidone (NMP). Each pore of the anode porous portion 11b is filled with a lithium-based metal in the form of powder; alternatively, the lithium-based metal is melted, filled into the pore, and then cooled.

The separation film 13 may be a thin film which has a dense structure (is structurally dense) and material, like that for the dense portion 12 of the solid high-ionic conductor.

Alternatively, a separation film used in a conventional lithium-sulfur battery may be used as the separation film 13.

The lithium-sulfur battery cell constructed as described above may be manufactured as follows.

Referring to FIGS. 4A through 4D, as shown in FIG. 4A, the cathode solid high-ionic conductor 10a and the cathode current collector 14, the anode solid high-ionic conductor 10b and the anode current collector 15, and the separation film 13, which form the lithium-sulfur battery cell 20, are provided. As shown in FIG. 4B, the cathode solid high-ionic conductor 10a and the anode solid high-ionic conductor 10b are bonded together by the separation film 13 and the cathode binder including the sulfur-based cathode active material, the conductive material. The binder is filled into each pore of the porous portion 11a of the cathode solid high-ionic conductor 10a in the form of slurry by using N-Methyl-2-pyrrolidone (NMP) as the solvent.

Next, as shown in FIG. 4C, the cathode current collector 14 is bonded to a surface (facing the separation film) of the cathode solid high-ionic conductor 10a in a sealed manner. Subsequently, the lithium-based metal is inserted into each pore of the porous portion 11b of the anode solid high-ionic conductor 10b in the form of a powder or is injected into each pore by using a melting method, thus filling into each pore.

To fill the cathode binder or lithium-based metal into each pore of a plurality of pores of the anode and cathode porous portions 11b and 11a, a melting method may be used. The melting method comprises melting and cooling the cathode binder or lithium-based metal and then filling it in a pressurized or decompressed manner. Or a thin-film coating method may be used for filling the cathode binder or lithium-based metal by depositing it using a metal deposition scheme, such as, chemical vapor deposition (CVD) or physical vapor deposition (PVD). Further, a powder particle paste filling method may be used for filling the cathode binder or lithium-based metal in the form of paste.

The pore size, porosity, specific surface area, specific volume, etc., of the anode porous portion 11b may have a different design than the cathode porous portion 11a to optimize conditions for improving battery capacity and lifespan.

As shown in FIG. 4D, the battery cell 20 is manufactured by bonding the anode current collector 15 onto the surface (facing the separation film) of the anode solid high-ionic conductor 10b.

The collectors 14 and 15 are configured to be operable at room and high temperatures, and are made from metallic materials (e.g., nickel alloys or the like) capable of minimizing corrosion that may be caused by electrochemical reaction.

The collectors 14 and 15 are in the form of metallic thin films that are attached onto a surface of the solid high-ionic conductors 10a and 10b, or are in the form of a collecting structure on a surface of the solid high-ionic conductors 10a and 10b, constructed by using various well-known methods, such as, a powder coating method, a thin-film coating method, etc.

The battery unit cell 20 constructed as described above is not limited in its area and shape. When the battery cell using the solid high-ionic conductors 10, 10a, 10b according to the present invention is manufactured, the thickness of the porous portions 11, 11a, 11b, that is, the thickness of an electrode varies among materials of a cathode and an anode filled into each pore of the porous portions 11, 11a, and 11b. The thickness of cathode 16 may be in a range of 20-500 μm. The thickness of anode 17 may be in a range of 5-500 μm. In certain embodiments, the thickness of the cathode 16 is 40-250 μm and the thickness of the anode 17 is 20-200 μm.

The separation film 13 between the cathode 16 and the anode 17 has a minimum thickness to have rigidity to maintain electric insulation between the anode 17 and the cathode 16 and to maintain the battery cell In certain embodiments, the separation film 13 has a thickness in a range of 1-20 μm.

A lithium-sulfur battery using a solid high-ionic conductor according to the present invention may be manufactured by depositing the above-described battery cell in multiple layers, and by adjusting the number of battery cells deposited. Further, energy and power range can be adjusted depending upon where the battery cell is applied.

A process of manufacturing the lithium-sulfur battery cell will be described in more detail through an example.

### EXAMPLE

By using Li_{1+x+y}Alₓ(Ti,Ge)₂₋ₓSi_{y}P_{3-y}O₁₂, which is an LISICON-based material, Each of first and second complex solid high-ionic conductors including a porous portion in an inner side and a dense portion in an outer side, is made from Li_{1+x+y}Alₓ(Ti,Ge)₂₋ₓSi_{y}P_{3-y}O₁₂, an LISICON-based material, by using a colloidal crystal template method.

The dense portions of the first and second complex solid high-ionic conductors are made in the form of circular rings having thicknesses of about 200 μm and diameters of 16 mm.

The porous portion of the first complex solid high-ionic conductor is made to have a plurality of pores, each of which is an open pore and has a size of about 1 μm and a porosity of 60%. The dense portion of the first complex solid high-ionic conductor is manufactured to have a width of about 1.5 mm (an outer diameter of 16 mm and an inner diameter of 14.5 mm).

The porous portion of the second complex solid high-ionic conductor is manufactured to have a plurality of pores, each of which has a size of about 0.5 μm and a porosity of 65%. The dense portion in the outer side is manufactured to have a width of about 1.5 mm (an outer diameter of 16 mm and an inner diameter of 14.5 mm).

The separation film inserted between the first and second complex solid high-ionic conductors is made to have a thickness of 100 μm by using the material same as that for the complex solid high-ionic conductor.

The first and second complex solid high-ionic conductors and the separation film as above described are coupled together by using a high-temperature ceramic adhesive.

For the first complex solid high-ionic conductor, a cathode binder, comprising sulfur as a cathode active material, super carbon (C) as a conductive material, and polyvinylidene fluoride (PVdF) as a binder, is made in the form of slurry by using NMP as a solvent. The cathode binder is filled by using a powder particle paste filling method into each pore of the porous portion of the first complex solid high-ionic conductor. The slurry is then dried and an aluminum foil as a current collector is coupled to a surface in a sealed manner by using an adhesive.

For the second complex solid high-ionic conductor, a micro lithium powder is filled in each pore of the porous portion in a glove box. A nickel foil as a current collector is coupled in a sealed manner. A measurement of an open circuit voltage (OCV) of a lithium-sulfur battery cell upon the completion of the drying processing was about 2.9V at room temperature.

The foregoing embodiment is merely an example, and in various ways, the complex solid high-ionic conductor may be manufactured. Further, an lithium-sulfur battery operable at room and high temperatures can also be manufactured by using the manufactured complex solid high-ionic conductor.

In the lithium-sulfur battery using the complex solid high-ionic conductor according to the present invention as described above, even when a sulfur-based cathode active material in an electrode is melted at a higher temperature than 120° C., the active material in the electrode does not leak to outside and is kept in the electrode, thus achieving normal electrochemical reaction.

In other words, the lithium-sulfur battery using the complex solid high-ionic conductor according to the present invention operates like the conventional lithium-sulfur battery at room temperature. When operated at a higher temperature than a melting temperature of sulfur (120° C.), sulfur does not leak to outside without the use of a separate cooling device in a battery system. Thus, a smooth electrochemical reaction can be made, thereby allowing a normal operation of the battery cell.

Moreover, the complex solid high-ionic conductor according to the present invention has an ion conductivity which increases as temperature increases When the battery cell using the complex solid high-ionic conductor operates at a high temperature, the movement speed of ions also increases, thus improving power density, while minimizing interfacial resistance. Furthermore, the operating temperature range of the battery is extended, and the burden on temperature adjustment in the battery system is reduced. As the use of a cooling device in the battery system is reduced, the complex solid high-ionic conductor offers advantages in terms of energy efficiency and volume energy density.

Furthermore, in the battery cell using the complex solid high-ionic conductor according to the present invention, the anode and cathode complex solid high-ionic conductors and the separation film are manufactured as one piece. Alternatively, they are separately manufactured in the form of green bodies and then are coupled using a binder, thereby providing a simple structure in processing for manufacturing the battery cell.

Therefore, the lithium-sulfur battery using the complex solid high-ionic conductor according to the present invention can be operated without sulfur leakage not only at room temperature, but also at a high temperature. When the lithium-sulfur battery operates at a high temperature at which ion conductivity increases, the movement speed of ions also increases, thus improving power density, providing high energy density and lifespan, and minimizing an interfacial resistance between the active material and the solid high-ionic conductor.

While exemplary embodiments of the present invention are described in detail, the scope of the present invention is not limited to the foregoing embodiments. It will be appreciated by those skilled in the art that various modifications and improvements using the basic concept of the present invention defined in the appended claims are also included in the protection scope of the present invention.

### DESCRIPTION OF REFERENCE NUMERALS

10: Complex Solid High-Ionic Conductor

10a: Solid High-Ionic Conductor for Cathode

10b: Solid High-Ionic Conductor for Anode

11, 11a, 11b: Porous Portion

12, 12a, 12b: Dense Portion

13: Solid High-Ionic Conductor for Separator

14: Current Collector for Cathode

15: Current Collector for Anode

16: Cathode

17: Anode

20: Battery Cell (Lithium-Sulfur Battery Cell)

What is claimed is:

1. A complex solid high-ionic conductor for a battery, the complex solid high-ionic conductor comprising:
a porous portion which is a porous flat-plate structure comprising a plurality of pores where an electrode active material can be filled; and
a dense portion encompassing a side edge of the porous portion,
wherein the dense portion is constructed to prevent an electrode active material from leaking at a temperature higher than a melting temperature of the electrode active material.

2. The complex solid high-ionic conductor of claim 1, wherein a reaction activation material selected from Al-based, In-based, Al₂O₃-based, ZrO₂-based, and ceramic-based materials is coated onto an interfacial surface, thereby improving an interfacial reaction between the porous portion and the electrode active material.

3. The complex solid high-ionic conductor of claim 1, wherein the porous portion is in a three-dimensional (3D) porous structure, and said porous portion is made by a method selected from a freeze casting method, a sol-gel method, a colloidal crystal template method, a carbon template method, an aerogel synthesis method, and a tape casting method.

4. The complex solid high-ionic conductor of claim 1, wherein each of the porous portion and the dense portion is made from a material selected from LiSICON-based, Thio-LiSICON-based, NaSiCON-based, Perovskite-based, Garnet-based, LiPON-based, LiPOS-based, LiSON-based, and LiSIPON-based materials.

5. A lithium-sulfur battery comprising:
a cathode comprising a cathode solid high-ionic conductor comprising a porous portion in a porous flat-plate structure, a dense portion encompassing a side edge of the porous portion, and a cathode binder filled into each pore of the porous portion;
an anode comprising an anode solid high-ionic conductor comprising a porous portion, in a porous flat-plate structure, a dense portion encompassing a side edge of the porous portion, and a lithium-based metal filled into each pore of the porous portion; and
a separation film inserted between the cathode and the anode,
wherein the cathode binder filled into the pore does not at a higher temperature than its melting temperature.

6. The lithium-sulfur battery of claim 5, wherein the cathode comprises a cathode current collector coupled to a surface of the cathode solid high-ionic conductor opposite to the separation film, and the anode comprises an anode current collector coupled to a surface of the anode solid high-ionic conductor opposite to the separation film.

7. The lithium-sulfur battery of claim 5, wherein the cathode has a thickness of 20-500 μm.

8. The lithium-sulfur battery of claim 5, wherein the anode has a thickness of 5-500 μm.

9. The lithium-sulfur battery of claim 5, wherein the separation film has a thickness of 1-20 μm.

10. The lithium-sulfur battery of claim 5, wherein a reaction activation material selected from Al-based, In-based, Al₂O₃-based, ZrO₂-based, and ceramic-based materials is coated onto an interfacial surface in one or both of the cathode and the anode, thereby improving an interfacial reaction between the solid high-ionic conductor and the electrode active material.

11. The lithium-sulfur battery of claim 5, wherein each of the porous portion, the dense portion, and the separation film is made from a material selected from LiSICON-based, Thio-LiSICON-based, NaSiCON-based, Perovskite-based, Garnet-based, LiPON-based, LiPOS-based, LiSON-based, and LiSIPON-based materials.

12. The lithium-sulfur battery of claim 5, wherein a cathode binder or lithium-based metal is filled into each pore of the porous portions by using a method selected from a melting method, a thin-film coating method, and a powder particle paste filling method.

13. An electrode for a lithium-sulfur battery, the electrode comprising:
a solid high-ionic conductor comprising a porous portion in a porous flat-plate structure, and a dense portion encompassing a side edge of the porous portion;
a cathode binder or lithium-based metal that is filled into each pore of the porous portion; and
a current collector coupled to a surface of the solid high-ionic conductor.
